(19) United States
(12) Patent Application Publication
(10) Pub. No.: US 2019/0014538 A1
(43) Pub. Date: Jan. 10, 2019

(54) BROADCAST TWT INDICATION IN BROADCAST PROBE RESPONSE AND FILS DISCOVERY FRAMES TO AID UNASSOCIATED STAS

(71) Applicant: QUALCOMM Incorporated, San Diego, CA (US)

(72) Inventors: Abhishek Pramod PATIL, San Diego, CA (US); Alfred ASTERJADHI, San Diego, CA (US); George CHERIAN, San Diego, CA (US)

(21) Appl. No.: 16/028,030

(22) Filed: Jul. 5, 2018

Related U.S. Application Data
(60) Provisional application No. 62/529,930, filed on Jul. 7, 2017.

(51) Int. Cl. H04W 52/02; H04W 48/10; H04W 74/00

(52) U.S. Cl. CPC H04W 52/0216; H04W 74/0833; H04W 74/008; H04W 48/10

(57) ABSTRACT

Techniques are provided for broadcast target wake time (TWT) indication in broadcast probe response and FILS discovery frames to aid unassociated wireless stations (STAs). Since broadcast probe response and/or FILS discovery frames are present to aid an unassociated STA discover an AP, an AP may advertise broadcast TWT in these frames when the AP intends to include at least one random access (RA) resource unit (RU) with AID12 set to 2045 (for unassociated STAs). In an aspect, an AP can include the broadcast TWT element in a broadcast probe response frame if a trigger frame (TF) in the TWT service period (SP) is to include at least one RA RU with AID12 set to 2045. In another aspect, an AP can include broadcast TWT element in a FILS discovery frame if the TF in the TWT SP is to include at least one RA RU with AID12 set to 2045.

### CLAIM OF PRIORITY UNDER 35 U.S.C. § 119

This application claims priority to U.S. Provisional Application No. 62/529,930, titled “BROADCAST TWT INDICATION IN BROADCAST PROBE RESPONSE AND FILS DISCOVERY FRAMES TO AID UNASSOCIATED STAS,” filed Jul. 7, 2017, which is assigned to the assignee hereof, and incorporated herein by reference in its entirety.

### BACKGROUND

Aspects of this disclosure relate generally to telecommunications, and more particularly to techniques for broadcast target wake time (TWT) indication in broadcast probe response and fast initial link setup (FILS) discovery frames to aid unassociated wireless stations (STAs).

The deployment of wireless local area networks (WLANs) in the home, the office, and various public facilities is commonplace today. Such networks typically employ a wireless access point (AP) that connects a number of STAs in a specific locality (e.g., home, office, public facility, etc.) to another network, such as the Internet or the like. A set of STAs can communicate with each other through a common AP in what is referred to as a basic service set (BSS). Nearby BSSs may have overlapping coverage areas and such BSSs may be referred to as overlapping BSSs or OBSSs. In some scenarios, communications that occur in nearby BSSs can result in collisions and failure in the transmission of information.

For unassociated STAs, especially in scenarios where multiple STAs may be contending for resources, it would be helpful to get information that would allow the STA to communicate with an AP. Accordingly, techniques described herein are intended to address this limitation.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Techniques are provided in connection with IEEE 802.11ax for broadcast target wake time (TWT) indication in broadcast probe response and FILS discovery frames to aid unassociated wireless stations (STAs). Since broadcast probe response and/or FILS discovery frames are present to aid an unassociated STA discover an AP, it is helpful to advertise broadcast TWT in these frames when the AP intends to include at least one random access (RA) resource unit (RU) with AID12 set to 2045 (for unassociated STAs). In an aspect, an AP can include the broadcast TWT element in a broadcast probe response frame if a trigger frame (TF) in the TWT service period (SP) is to include at least one RA RU with AID12 set to 2045. In another aspect, an AP can include a broadcast TWT element in a FILS discovery frame if the TF in the TWT SP is to include at least one RA RU with AID12 2045. Moreover, the AP can include the broadcast TWT element in a beacon frame.

In an aspect, the disclosure includes a method for wireless communications. The method may include generating, at an AP, a broadcast probe response frame, a FILS discovery frame, or both. The method may include including a broadcast TWT element in the broadcast probe response frame, the FILS discovery frame, or both in response to the AP being scheduled to transmit a trigger frame during a TWT SP with at least one RA RU for an unassociated wireless STA. The method may include transmitting the broadcast probe response frame, the FILS discovery frame, or both.

In another aspect, the disclosure includes an AP for wireless communications. The AP may include a transceiver, a memory, and a processor communicatively coupled with the transceiver and the memory. The processor may be configured to generate, at the AP, a broadcast probe response frame, a FILS discovery frame, or both. The processor may be configured to include a broadcast TWT element in the broadcast probe response frame, the FILS discovery frame, or both in response to the AP being scheduled to transmit a trigger frame during a TWT SP with at least one RA RU for an unassociated wireless STA. The processor may be configured to transmit the broadcast probe response frame, the FILS discovery frame, or both.

In another aspect, the disclosure includes a method for wireless communications for a wireless station. The method may include detecting, at an unassociated wireless STA, a broadcast TWT element in a broadcast probe response frame, a FILS discovery frame, or both received from an AP in response to the AP being scheduled to transmit a trigger frame during a TWT SP with at least one RA RU for the unassociated STA. The method may include communicating with the AP during the TWT SP based at least in part on information provided by the broadcast TWT element.

In another aspect, the disclosure includes a wireless station for wireless communications.

The wireless station may include a transceiver, a memory, and a processor communicatively coupled to the transceiver and the memory. The processor may be configured to detect, at the wireless station, being an unassociated wireless STA, a broadcast TWT element in a broadcast probe response frame, a FILS discovery frame, or both received from an AP in response to the AP being scheduled to transmit a trigger frame during a TWT SP with at least one RA RU for the unassociated STA. The processor may be configured to communicate with the AP based at least in part on information provided by the broadcast TWT element and during the TWT SP.

Various aspects and features of the disclosure are described in further detail below with reference to various examples thereof as shown in the accompanying drawings. While the present disclosure is described below with reference to various examples, it should be understood that the present disclosure is not limited thereto. Those of ordinary skill in the art having access to the teachings herein will recognize additional implementations, modifications, and examples, as well as other fields of use, which are within the scope of the present disclosure as described herein, and with respect to which the present disclosure may be of significant utility.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout, where dashed lines may indicate optional components or actions, and wherein:

FIG. 1 is a schematic diagram illustrating an example of a wireless local area network (WLAN) deployment.

FIG. 2 is a diagram illustrating aspects of embedding a broadcast TWT element in a broadcast probe response, a FILS discovery frame, and a beacon frame in accordance with various aspects of the present disclosure.

FIG. 3 is a schematic diagram illustrating an example broadcast TWT element.

FIG. 4 is a schematic diagram illustrating an example uplink OFDM-based random access (UORA) procedure.

FIG. 5 is a schematic diagram of a communication network including aspects of an AP configured for broadcast TWT indication to aid unassociated STAs, in accordance with various aspects of the present disclosure.

FIG. 6 is a schematic diagram of a communication network including aspects of an STA configured for broadcast TWT indication to aid unassociated STAs, in accordance with various aspects of the present disclosure.

FIG. 7 is a flow diagram illustrating an example of a method for an AP, in accordance with various aspects of the present disclosure.

FIG. 8 is a flow diagram illustrating an example of a method for an STA, in accordance with various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts. In an aspect, the term “component” as used herein may be one of the parts that make up a system, may be hardware or software, and may be divided into other components.

In IEEE 802.11ax, a mechanism is provided for an AP to transmit a trigger frame (TF) to indicate resource units (RUs) to client devices (e.g., STAs) so that such devices can use the RUs to send uplink (UL) traffic to the AP. An AP can indicate one or more RUs for random access (RA) in a trigger frame. The RA RUs are separated for associated and unassociated STAs based on the AID12 values carried in the user info field of the TF. The AID12 value of 0 indicates RA RUs for associated STAs while the AID12 value of 2045 is reserved to indicate RA RUs for unassociated STAs. It should be appreciated that although the AID12 value of 2045 has been specified in, for example, 802.11ax D3.0 to indicate an unassociated STA, another value could be used instead. As described herein, the term “associated” may refer to an STA that is associated with the particular AP transmitting the TF, while the term “unassociated” may refer to an STA that is not associated with the particular AP transmitting the TF.

A broadcast TWT element can carry information that can be used by STAs to know when to expect a TWT SP during which the AP is available to service the STAs. A TWT Flow Identifier value 2 (in the Broadcast TWT element) indicates that the AP will be sending trigger frames (TFs) containing RA RU. However, the TWT Flow Identifier value does not explicitly indicate whether or not the RA RUs in the TFs would be for associated STAs, unassociated STAs, or both. This can be ambiguous to an unassociated STA (e.g., the unassociated STA does not know if the TF will include RA with AID12 value of 2045) and affect the unassociated STA's power state (e.g., unassociated STA would be in active state during the TWT SP to receive the trigger frame expecting an RA RU with AID12 of 2045 but the AP never includes such an RU). Moreover, as currently described in the standard, a high efficiency (HE) AP may include the broadcast TWT element in a beacon or a broadcast probe response frame.

The techniques described herein provide for a mechanism that allows unassociated STAs to know when to expect a RA RU that they can use to transmit frames (e.g., management frames) to the AP by following the random access procedure described in the IEEE 802.11ax specification. These techniques can be applied to an upcoming IEEE 802.11ax-extention to 6G operation or next generation Wi-Fi (e.g., wireless local area networks or WLAN) in which all the operations in the BSS are expected to be AP-controlled, and client access (including unassociated STAs) is fully scheduled by the AP.

Since broadcast probe response and/or FILS discovery frames are monitored by unassociated STAs and are present to aid an unassociated STA discover an AP, it is helpful to advertise broadcast TWT in these frames only when the AP intends to include at least one random access (RA) resource unit (RU) with AID12 set to 2045 (for unassociated STAs) in the TWT SP associated with the TF. Additionally, it is helpful when the AP only advertises those TF that include at least one RA RU for unassociated STAs. In an aspect, an AP can include the broadcast TWT element in a broadcast probe response frame or a FILS discovery frame if a trigger frame (TF) in the TWT service period (SP) is to include at least one RA RU with AID12 set to 2045. In another aspect, an AP can include broadcast TWT element in a FILS discovery frame if the TF in the TWT SP is to include at least one RA RU with AID12 set to 2045. Moreover, the AP can include a broadcast TWT element in a beacon frame. In an aspect, the broadcast TWT element in a beacon frame may include information regarding TFs that do not include at least one RA RU for unassociated STAs.

Aspects of techniques for broadcast TWT indication in broadcast probe response and FILS discovery frames to aid unassociated STAs are provided in more detail in the following description and related drawings directed to specific disclosed aspects. The present methods and apparatuses may provide an efficient solution, as compared to current proposals, as described above. Alternate aspects may be devised without departing from the scope of the disclosure. Additionally, well-known aspects of the disclosure may not be described in detail or may be omitted so as not to obscure more relevant details. Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

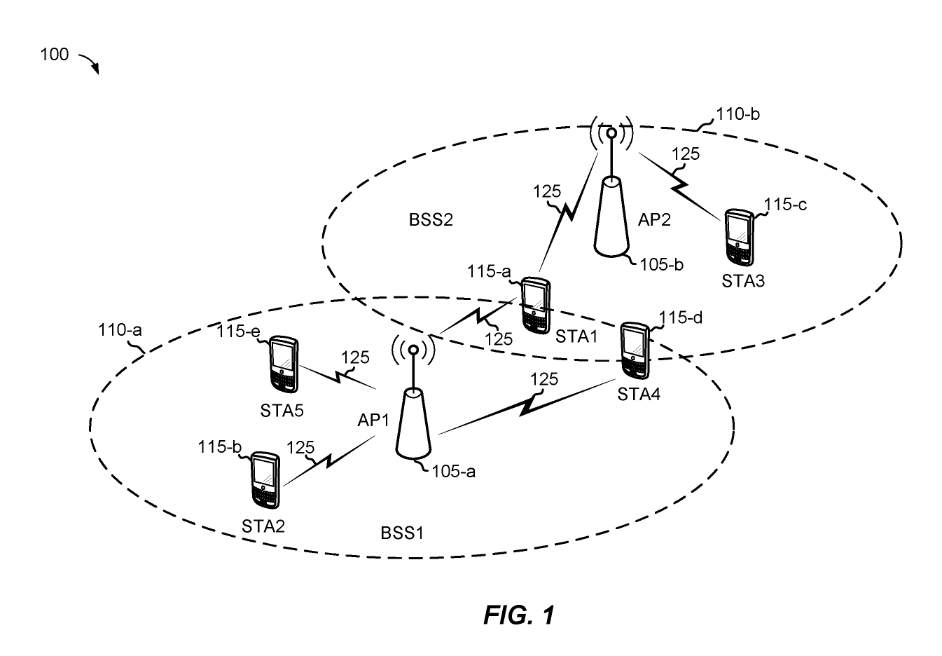

FIG. 1 is a wireless communication system 100 illustrating an example of a wireless local area network (WLAN) deployment in connection with various techniques described herein. The WLAN deployment may include one or more access points (APs) 105 and one or more wireless stations (STAs) 115 associated with a respective AP. In this example, there are only two APs deployed for illustrative purposes: AP1 105-a in basic service set 1 (BSS1) and AP2 105-b in BSS2. AP1 105-a is shown having at least two associated STAs (STA1 115-a, STA2 115-b, STA4 115-d, and STA5 115-e) and coverage area 110-a, while AP2 105-b is shown having at least two associated STAs (STA1 115-a and STA3 115-c) and coverage area 110-b. In the example of FIG. 1, the coverage area of AP1 105-a overlaps part of the coverage area of AP2 105-b such that STA1 115-a is within the overlapping portion of the coverage areas. The number of BSSs, APs, and STAs, and the coverage areas of the APs described in connection with the WLAN deployment of FIG. 1 are provided by way of illustration and not of limitation. Moreover, aspects of the various techniques described herein are at least partially based on the example WLAN deployment of FIG. 1 but need not be so limited.

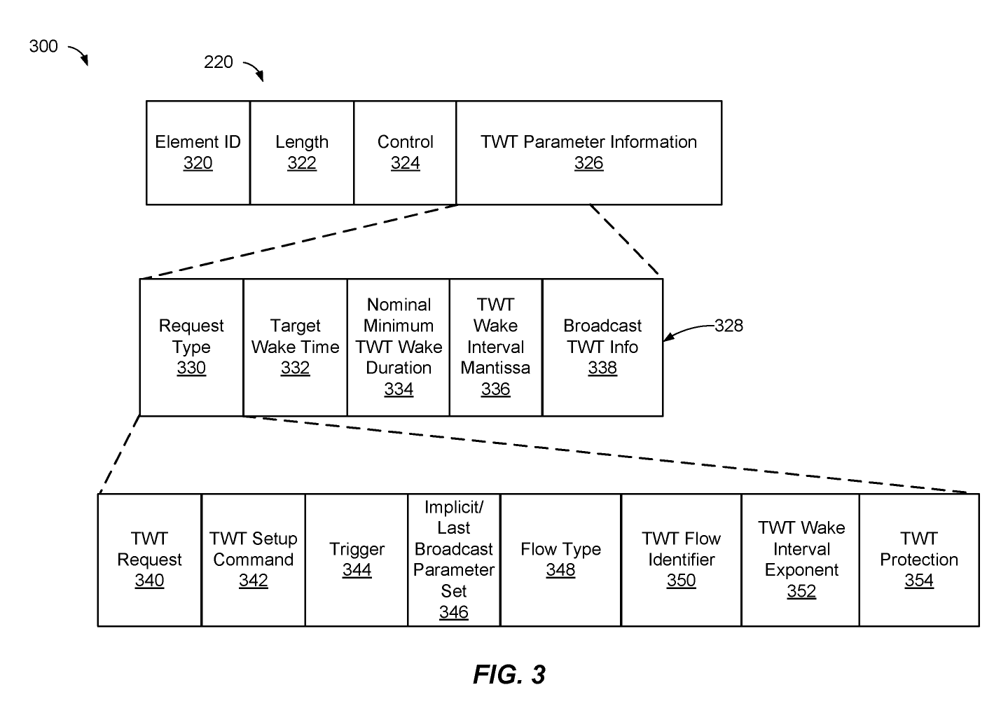

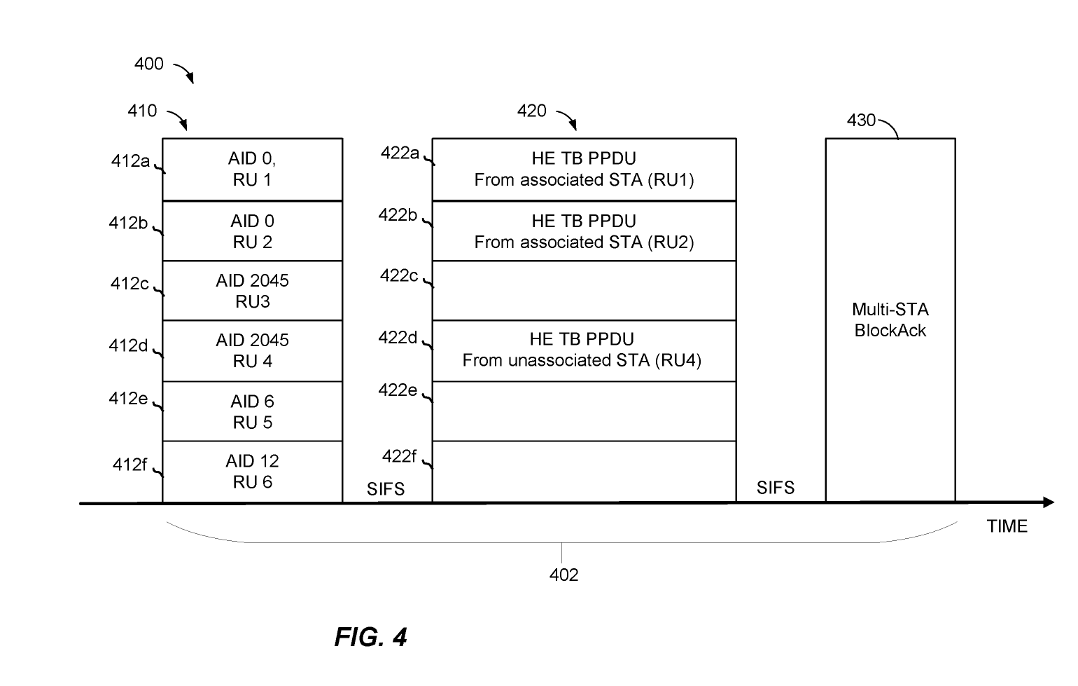

The APs (e.g., AP1 105-a and AP2 105-b) shown in FIG. 1 are generally fixed terminals that provide backhaul services to STAs within its coverage area or region. In some applications, however, the AP may be a mobile or non-fixed terminal. The STAs (e.g., STA1 115-a, STA2 115-b, STA3 115-c, STA4 115-d, and STA5 115-e) shown in FIG. 1, which may be fixed, non-fixed, or mobile terminals, utilize the backhaul services of their respective AP to connect to a network (see e.g., network 318 in FIGS. 3 and 4), such as the Internet. Examples of an STA include, but are not limited to: a cellular phone, a smart phone, a laptop computer, a desktop computer, a personal digital assistant (PDA), a personal communication system (PCS) device, a personal information manager (PIM), personal navigation device (PND), a global positioning system, a multimedia device, a video device, an audio device, a device for the Internet-of-Things (IoT), or any other suitable wireless apparatus requiring the backhaul services of an AP. An STA may also be referred to by those skilled in the art as: a subscriber station, a mobile unit, a subscriber unit, a wireless unit, a remote unit, a mobile device, a wireless device, a wireless communications device, a remote device, a mobile subscriber station, an access terminal, a mobile terminal, a wireless station, a remote terminal, a handset, a user agent, a mobile client, a client, user equipment (UE), or some other suitable terminology. An AP may also be referred to as: a base station, a base transceiver station, a radio base station, a radio transceiver, a transceiver function, a small cell, or any other suitable terminology. The various concepts described throughout this disclosure are intended to apply to all suitable wireless apparatus regardless of their specific nomenclature.

Each of STA1 115-a, STA2 115-b, STA3 115-c, STA4 115-d, and STA5 115-e may be implemented with a protocol stack. The protocol stack can include a physical layer for transmitting and receiving data in accordance with the physical and electrical specifications of the wireless channel, a data link layer for managing access to the wireless channel, a network layer for managing source to destination data transfer, a transport layer for managing transparent transfer of data between end users, and any other layers necessary or desirable for establishing or supporting a connection to a network.

Each of AP1 105-a and AP2 105-b can include software applications and/or circuitry to enable associated STAs to connect to a network via communications links 125. The APs can send frames to their respective STAs and receive frames from their respective STAs to communicate data and/or control information (e.g., signaling).

Each of AP1 105-a and AP2 105-b can establish a communications link 125 with an STA 115 that is within the coverage area of the AP. Communications links 125 can comprise communications channels that can enable both uplink and downlink communications. When connecting to an AP, an STA can first authenticate itself with the AP and then associate itself with the AP. Once associated, a communications link 125 can be established between the AP and the STA such that the AP and the associated STA can exchange frames or messages through a direct communications channel.

While aspects of the present disclosure are described in connection with a WLAN deployment or the use of IEEE 802.11-compliant networks, those skilled in the art will readily appreciate, the various aspects described throughout this disclosure may be extended to other networks employing various standards or protocols including, by way of example, BLUETOOTH® (Bluetooth), HiperLAN (a set of wireless standards, comparable to the IEEE 802.11 standards, used primarily in Europe), and other technologies used in wide area networks (WAN)s, WLANs, personal area networks (PAN)s, or other suitable networks now known or later developed.

In an aspect, an AP 105 and an STA 115 may perform various operations for broadcast TWT indication in broadcast probe response and FILS discovery frames to aid unassociated STAs.

As described above, target wake time or TWT is an optional mechanism supported by IEEE 802.11ax. There are several variants of TWT, including announced TWT and unannounced TWT. In TWT, an AP can define one or more broadcast TWT service periods (SPs), which are used by the AP to inform nearby STAs that during these periods the AP is available and can service the STAs. The broadcast TWT SPs can cover different time periods, although they may overlap in some instances. From the STA's perspective, if an AP were to announce a couple of broadcast TWT SPs, the STA could subscribe to one or both and let the AP know that this particular client is going to be available and awake during the time intervals associated with the subscribed broadcast TWT SPs. As such, the AP is aware that if there is some information that needs to be transmitted to this particular client, the client will be present during the indicated time intervals.

Therefore, from the perspective of the AP, the AP can know if a particular client device (e.g., non-AP STA) is going to be present during the time intervals associated with the TWT SPs. From the client device's point of view (e.g., the non-AP STA), the device knows that it indicated to the AP the times that it is going to be available, which means that outside those times the client device is not expecting anything from the AP so the client device can perform other functions or, in some cases, go to sleep. One of the reasons for the concept of TWT in IEEE 802.11ax is to provide an unambiguous mechanism to allow the AP and the STA to know the time intervals during which the STA is available and can be serviced by the AP.

TWT can also be differentiated between negotiated TWT, in which there is a one-to-one scheduling between an AP and an STA, and the broadcast TWT discussed above, where multiple STAs or client devices interact with an AP.

For broadcast TWT, there can be two different variants identified by a flow identifier. For example, there is a TWT flow identifier 1 (or set to 1) and a TWT flow identifier 2 (or set to 2). When the TWT flow identifier is 1 or set to 1, during a broadcast TWT SP the AP will send a trigger frame to which the STAs can respond and send uplink traffic. In these types of TWT SPs, an STA typically cannot send information to an AP during a broadcast TWT SP while the AP can send information to the STA. The STA may not send information to the AP (e.g., uplink traffic) until or unless the AP sends the trigger frame. This mechanism provides a form of controlled scheduled access.

A TWT flow identifier of 2 or set to 2 is sent when the trigger frames may also contain or include random access resource units (RA RUs). There are two kinds of random access, one for associated STAs and another for unassociated STAs, which can be identified based on an AID12 value. When the AID12 value is set to 0, the random access is for associated STAs, when the AID12 value is set to 2045, the random access is for unassociated STAs.

If a STA is an associated STA, the AP may not have sent to that STA a directed trigger frame. The trigger frame can have several RUs, and RUs with the same AID12 value as that of the STA mean that the RUs are directed to the STA. This also means that the STA may not access the AP using other RUs, including using RA RUs. If the STA is not listed in any of the scheduled or directed RUs, then the STA may choose to use an RA RU as long as certain conditions are met. In short, when the TWT identifier is 2 or set to 2 then the trigger frame can include at least one RU for a device.

From the perspective of an unassociated STA, it would be useful to know what is the broadcast TWT SP schedule of nearby APs, and more particularly, which are the TWT broadcast SPs during which the respective AP is going to send a trigger frame with RA RU for use by unassociated STAs. Various techniques described herein are intended to address this aspect.

As it currently stands, the IEEE 802.11ax standard does not specify or explicitly signal which of the broadcast TWT SPs have RA RUs for unassociated STAs. Accordingly, for example, a STA may attempt to receive every TF, including those with no RA RUs for unassociated STAs, which would reduce opportunities for power saving. One aspect of the proposed solution is to add certain conditions, requirements, or behavior so that an AP includes a broadcast TWT element in a broadcast probe response or FILS discovery frame only when the broadcast TWT SP has a trigger frame with at least one RU for AID12 with a value of 2045 (e.g., for unassociated STAs).

Typically, an AP sends a probe response to a probe request from an STA. When a device or STA is trying to find an AP, it may send a probe request, to which the AP replies by sending a probe response. The AP may send instead a broadcast probe response when collectively addressing multiple STAs. An AP can send a broadcast probe response containing (e.g., including, embedding) a broadcast TWT element. For an unassociated STA, receiving a broadcast TWT element as part of a broadcast probe response does not provide much information as such. But adding the conditions that the broadcast TWT element is only added to the broadcast probe response when the TWT element includes a TWT flow identifier of 2 or set to 2 and the AP intends to send a trigger frame with at least one RU (e.g., RA RU) of AID12 value of 2045 provides additional information to the unassociated STA when receiving the broadcast TWT element in the broadcast probe response.

A similar approach can be taken with FILS discovery frames as with the broadcast probe response. The FILS discovery frames are sent occasionally, sometimes every 20 milliseconds, or every 50 milliseconds, for example. These frames are short frames that carry enough information for a device to discover an AP (e.g., to let a device know that there is an AP in a particular channel). Presently, a device or STA may need to wait as long as 100 milliseconds for the next beacon frame to be sent for the device to discover an AP. A device can actively probe (e.g., send a probe request and receive a probe response), but if the device is to take a passive approach and not actively probe, the device could end up staying in a channel for a long time before discovering an AP or realizing that there is no AP in the channel. To avoid this issue, IEEE 802.11ai introduced the FILS discovery frames, which can be transmitted by an AP at much shorter intervals than a beacon frame, and can be used by an STA to discover an AP in a channel without having to wait until the next beacon frame. The FILS discovery frames can include sufficient information to let the STA know when to expect the next beacon frame, which allows the STA to go to sleep and wake up for the next beacon frame, or switch to another channel and come back for the next beacon frame.

Accordingly, an AP can also advertise the broadcast TWT element in a FILS discovery frame under similar conditions to those applied for a broadcast probe response. That is, the broadcast TWT element is only added to a FILS discovery frame when the broadcast TWT element includes a TWT flow identifier of 2 or set to 2 and the AP intends to send a trigger frame with at least one RU (e.g., RA RU) having an AID12 value of 2045.

When an unassociated STA detects or identifies a broadcast TWT element in a broadcast probe response or a FILS discovery frame, the unassociated STA may determine when a broadcast TWT SP will occur and that the broadcast TWT SP will include a trigger frame with at least one RU that the unassociated STA can use to communicate with the AP (e.g., at least one RU for AID12 with value of 2045).

In another aspect, an associated HE STA that receives a beacon frame or a management frame containing a TWT element that has a value of 1 in the Broadcast subfield and a value of 2 in the TWT flow identifier subfield may enter the doze state until the start of that TWT SP.

In another aspect, an associated STA can follow a random access procedure (e.g., UL OFDMA-based random access (UORA)) when the AP includes one or more RUs with AID12 value equal to 0 in a trigger frame transmitted during the broadcast TWT SP.

In another aspect, an unassociated STA (e.g., a high efficiency STA or HE STA), such as STA 115, that receives a beacon frame or a broadcast probe response frame or a FILS discovery frame containing a TWT element that has a value of 1 in the broadcast subfield and a value of 2 in the TWT flow identifier subfield may enter the doze state until the start of that TWT SP. An unassociated STA can follow a random access procedure (e.g., UL OFDMA-based random access (UORA)) if the AP includes one or more RUs with AID12 value set to 2045 in the trigger frame transmitted during the broadcast TWT SP.

In yet another aspect, a TWT scheduling AP (e.g., AP 105) may include a broadcast TWT element in broadcast probe response frames when both the following conditions are satisfied: (1) the STA's dot11FILSOmitReplicateProbeResponses is equal to true, and (2) the TWT flow identifier is set to 2 and the AP intends to transmit a trigger frame during the TWT SP with at least one RU with AID12 set to 2045.

In another aspect, a TWT scheduling AP (e.g., AP 105) may include a broadcast TWT element in FILS discovery frames only if the TWT flow identifier is set to 2 and the AP intends to transmit a trigger frame during the TWT SP with at least one RU with AID12 set to 2045.

In another aspect, a FILS discovery frame may include a broadcast TWT element, aspects of which are defined in IEEE 802.11ax section 9.4.2.200 (TWT element), for making decisions related to power save (e.g., power save with UORA)) and/or transmissions to the AP (e.g., UL OFDMA-based random access (UORA)).

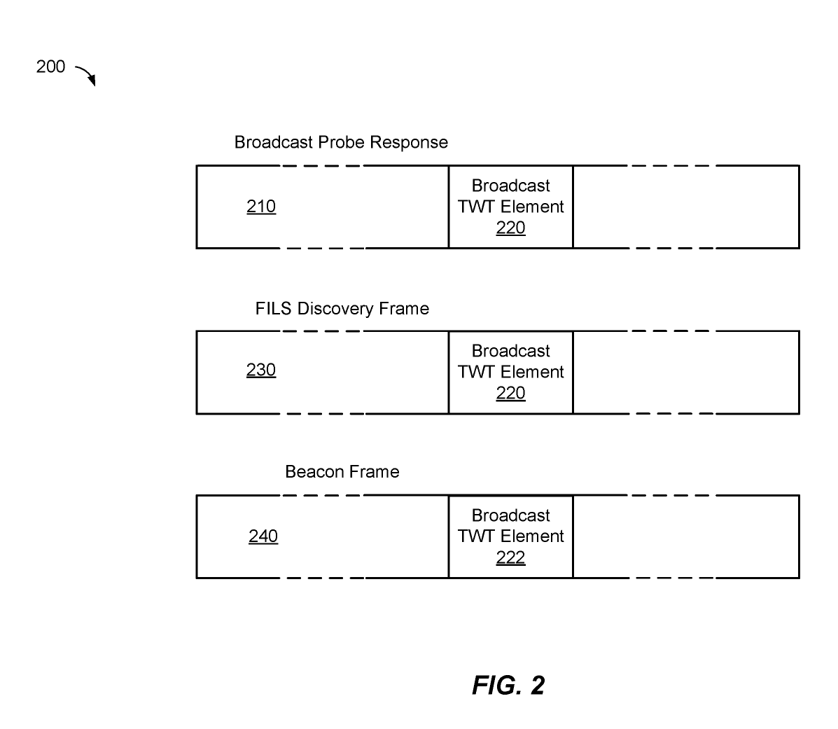

FIG. 2 is a diagram 200 illustrating aspects of embedding or including a broadcast TWT element in a broadcast probe response, a FILS discovery frame, and a beacon frame for TWT indication to aid unassociated STAs. As shown in FIG. 2, a broadcast probe response frame 210 can include or contain a broadcast TWT element 220 when certain conditions, as described above, are met. Similarly, a FILS discovery frame 230 can include or contain a broadcast TWT element 220 when certain conditions, as described above, are met. Moreover, a beacon frame 240 can include or contain a broadcast TWT element 222. In an aspect, the broadcast TWT element 222 located in the beacon frame 240 may be different than the broadcast TWT element 220 located in the broadcast probe response frame 210 and/or the FILS discovery frame 230. The broadcast TWT element 220 located in the broadcast probe response frame 210 and/or the FILS discovery frame 230 may be limited to include only those TWT parameter information sets that correspond to trigger frame including one or more RUs with AID12 value set to 2045. In contrast, the broadcast TWT element 222 located in the beacon frame 240 may include a TWT parameter information set for each trigger frame scheduled by the AP.

FIG. 3 is a diagram 300 illustrating additional aspects of a broadcast TWT element 220 that may be included in a broadcast probe response or FILS discovery frame. The broadcast TWT element 220 may include an element ID 320 field, a length field 322, a control field 324, and a TWT Parameter Information field 326. The element ID 320 field may identify the broadcast TWT element 220 as a TWT element. The length field 322 may indicate a length of the broadcast TWT element 220. The a control field 324 may include an NDP paging indicator, responder PM mode and negotiation type. The TWT Parameter Information field 326 may include one or more TWT parameter sets 328. A TWT parameter set 328 may include a request type field 330, a target wake time field 332, a nominal minimum TWT wake duration 334, a TWT wake interval mantissa field 336 and a broadcast TWT info field 338. The request type field 330 may indicate various properties of the TWT request, as discussed in further detail below. The target wake time field 332, the nominal minimum TWT wake duration 334, and the TWT wake interval mantissa field 336 may be interpreted based on the negation type indicated by the control field 324, but generally describe the start time of a TWT SB, duration between TWT SBs, and length of TWT SBs. That is, the TWT parameter set 328 provides a STA with information for monitoring the TWT SB. The broadcast TWT info field 338 provides information regarding the broadcast TWT including a broadcast TWT persistence exponent, broadcast TWT ID, and broadcast TWT persistence mantissa.

The request type field 330 may include a TWT request subfield 340, TWT setup command subfield 342, trigger subfield 344, implicit/last broadcast parameter set subfield 346, flow type subfield 348, TWT flow identifier subfield 350, TWT wake interval exponent subfield 352, and TWT protection subfield 354. The TWT request subfield 340 may indicate whether the TWT requests or schedules an STA or AP. The TWT setup command subfield 342 may indicate a type of TWT command. The trigger subfield 344 may indicate whether or not the TWT SP indicated by the TWT element includes trigger frames. In an aspect, the trigger subfield 344 may be set to 1 because the scheduled TWT SP includes at least one trigger frame indicating RA RU for unassociated STA. The implicit/last broadcast parameter set subfield 346 may indicate whether the current TWT parameter set 328 is the last TWT parameter set in the broadcast TWT element 220. The TWT flow identifier subfield 350 may identify the specific information for this TWT request. In particular, the TWT flow identifier subfield 350 may be set to 2 to indicate that trigger frames transmitted by the TWT scheduling AP during the broadcast TWT SP contain at least one RU for random access. In an aspect, a TWT flow identifier subfield 350 included in a broadcast TWT element may be referred to as a broadcast TWT recommendation. That is, the broadcast TWT recommendation may refer to the same subfield as the TWT flow identifier subfield 350. Therefore, as used herein, the term TWT flow identifier is synonymous with the term broadcast TWT recommendation. The TWT wake interval exponent subfield 352 may be set to a value of the exponent of the TWT wake interval value in microseconds base 2. That is, the TWT wake interval of a requesting STA may be equal to TWT Wake Interval Mantissa field 336 times 2^{(TWT wake interval exponent subfield 352)}. The TWT protection subfield 354 may be used to indicate whether other STAs should protect the TWT SPs from contention.

FIG. 4 is a diagram 400 illustrating an example uplink OFDMA-based random access (UORA) procedure during a TWT SP 402. The UORA procedure may start with a trigger frame 410 transmitted by an AP 105 , followed by a set of RA-RUs 420, and a multi-STA block acknowledgment 430. The trigger frame 410 may be separated from the set of RA-RUs 420 by a short interframe space (SIF), and the set of RA-RUs 420 may be separated from the multi-STA block acknowledgment 430 by another SIF. In an aspect, the trigger frame 410 may be transmitted in the TWT SP 402 indicated by a TWT element in a broadcast probe response or FILS discovery frame. The trigger frame 410 may include multiple random access resource unit (RA-RU) indications 412. For example, when configured with a 26-tone RU, the trigger frame 410 may include up to 9 RA-RU indications 412 for a 20 MHz HE PPDU. Each RA-RU indication 412 may correspond to an RA-RU that may be utilized by a STA and may include an AID value indicating which STA(s) may utilize the RA-RU. For example, as illustrated RA-RU indications 412a and 412b may have an AID value of 0 indicating that the corresponding RA-RU may be utilized by associated STAs, the RA-RU-indications 412c and 412d may have an AID value of 2045 indicating that the corresponding RA-RU may be utilized by unassociated STAs, and the RA-RU indications 412e and 412f may have AID values of specific STAs indicating that the corresponding RA-RU may only be utilized by the specific STA.

An STA may randomly select an applicable indicated RA-RU using a contention procedure when the STA has a frame to transmit to the AP. In the contention procedure, the STA may maintain an OBO counter and randomly select the applicable frame when the OBO counter reaches 0. For example, as illustrated, the unassociated STA may select among RA-RU 422c and 422d to transmit the HE TB PDU. For instance, the unassociated STA may select RA-RU 422d for transmitting a HE TB PDU, which may include a management frame, for example, for associating with the AP 105. It should be noted that the unassociated STA may transmit concurrently with one or more associated or unassociated STAs utilizing other RA-RUs without collision. In the case that two unassociated STAs randomly select the same RA-RU, the transmission may fail and a retransmission procedure may be utilized.

The Multi-STA Block Acknowledgment 430 may be transmitted by the AP 105 and indicate a status of each RA-RU 422. The Multi-STA Block Acknowledgment 430 may include a bitmap indicating the status of each RA-RU 422.

As discussed above, a broadcast probe response or FILS discovery frame may include a TWT element only when a trigger frame includes at least one RA-RU indication 412 that indicates an RA-RU 422 that may be utilized by an unassociated STA. In an aspect, the broadcast probe response or FILS discovery frame may include the TWT parameter set 328 for only the trigger frame 410 including the RA-RU indication 412 indicating the unassociated STA (e.g., with AID value 2045).

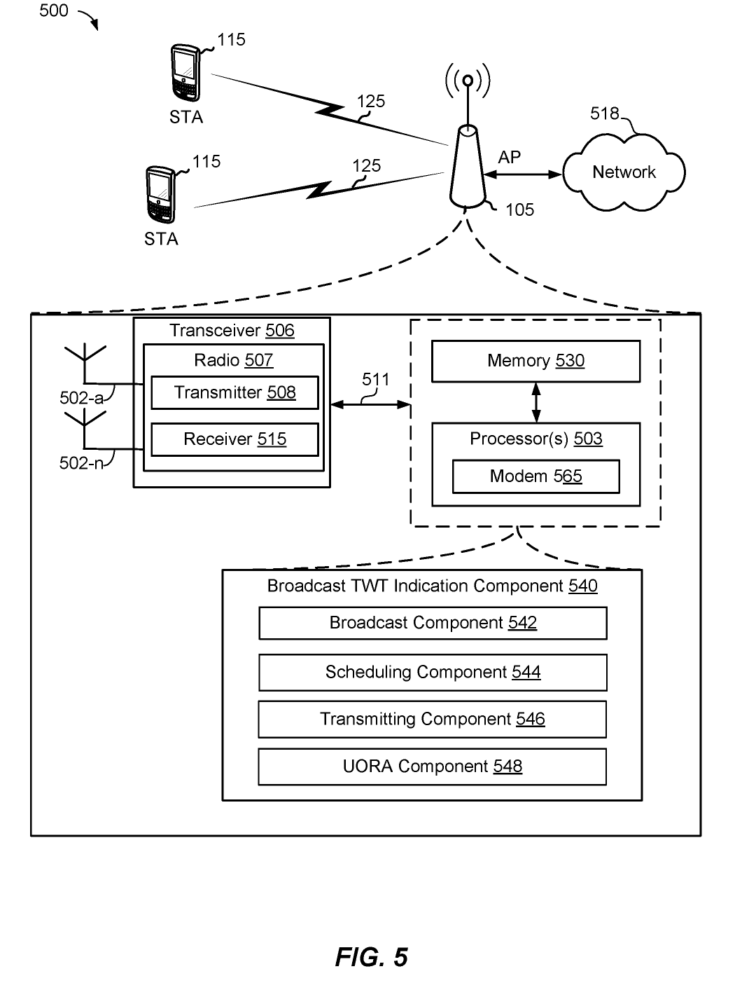

Referring to FIG. 5, in an aspect, a wireless communication system 500 includes multiple STAs 115 in wireless communication with at least one AP 105 connected to network 518. The STAs 115 may communicate with network 518 via AP 105. In an example, STAs 115 may transmit and/or receive wireless communication to and/or from AP 105 via one or more communications links 125. Such wireless communications may include, but are not limited to, data, audio and/or video information. In some instances, such wireless communications may include control or similar information. In an aspect, an AP, such as AP 105 may be configured to perform techniques described herein for broadcast TWT indication in broadcast probe response and FILS discovery frames to aid unassociated STAs.

In accordance with the present disclosure, AP 105 may include a memory 530, one or more processors 503 and a transceiver 506. The memory 530, the one or more processors 503 and the transceiver 506 may communicate internally via a bus 511. In some examples, the memory 530 and the one or more processors 503 may be part of the same hardware component (e.g., may be part of a same board, module, or integrated circuit). Alternatively, the memory 530 and the one or more processors 503 may be separate components that may act in conjunction with one another. In some aspects, the bus 511 may be a communication system that transfers data between multiple components and subcomponents of the AP 105. In some examples, the one or more processors 503 may include any one or combination of modem processor, baseband processor, digital signal processor, and/or transmit processor. Additionally or alternatively, the one or more processors 503 may include a modem 565 having a broadcast TWT indication component 540 for carrying out one or more methods or procedures described herein in connection with an AP. The broadcast TWT indication component 540 may comprise hardware, firmware, and/or software and may be configured to execute code or perform instructions stored in a memory (e.g., a computer-readable storage medium). For example, the broadcast TWT indication component 540 may include a broadcast component 542, a scheduling component 544, a transmitting component 546, and a UORA component 548.

The broadcast component 542 may include hardware, firmware, and/or software executable by a processor and may be configured to generate one or more broadcast messages such as a beacon, broadcast probe response, or FILS discovery frame. The broadcast component 542 may periodically generate the beacon and/or FILS discovery frame. In an aspect, the FILS discovery frame may be generated on a shorter period than the beacon. The broadcast component 542 may generate the broadcast probe response in response to receiving one or more probe requests. In an aspect, the broadcast component 542 may generate the broadcast probe response to include a union of all information requested in multiple received probe requests. For example, if a first STA transmits a probe request asking for element x and a second STA transmits a probe request asking for element y, then the broadcast probe request may include element x and element y. As another example, if the first STA indicates support for feature m and the second STA indicates support for feature n, if the AP supports only feature m, the broadcast probe response may indicate support for only feature m. As another example, if indicates support for one authentication protocol and the second STA indicates support for a different authentication protocol and if the AP supports both authentication protocols, the broadcast probe response may indicate support for both authentication protocols. Additionally, the broadcast probe response may satisfy any timing requirements of the multiple probe requests. For example, if the first STA indicates that the first STA will wait on the channel of the AP for 8 ms to get a response and the second STA indicates that the second STA will wait for up to 10 ms to get a probe response, the AP should respond within 8 ms of the probe request of the first STA to satisfy both timing requirements.

The scheduling component 544 may include hardware, firmware, and/or software executable by a processor and may be configured to allocate resources for transmissions. For example, the scheduling component 544 may schedule service periods including trigger frames and RA RUs. The scheduling component 544 may assign the RA RUs to associated and/or unassociated STAs. In response to the scheduling component 544 allocating a scheduled RA RU for at least one unassociated STA, the scheduling component 544 may include a broadcast TWT element indicating the trigger frame in a broadcast probe response frame or FILS discovery frame, or both.

The transmitting component 546 may include hardware, firmware, and/or software executable by a processor and may be configured to transmit one or more broadcast messages such as a beacon, broadcast probe response, or FILS discovery frame. In particular, the transmitting component 546 may transmit the broadcast probe response or FILS discovery frame including the broadcast TWT element indicating the trigger frame.

The UORA component 548 may include hardware, firmware, and/or software executable by a processor and may be configured to perform a UORA procedure. For example, the UORA component 548 may transmit a trigger frame, receive one or more HE TB PPDUs, and transmit a Multi-STA acknowledgment.

In some examples, the memory 530 may be configured for storing data that is used in connection with local applications, and/or in connection with the broadcast TWT indication component 540 and/or one or more of any subcomponents being executed by the one or more processors 503. Memory 530 can include any type of computer-readable medium usable by a computer or processor 503, such as random access memory (RAM), read only memory (ROM), tapes, magnetic discs, optical discs, volatile memory, non-volatile memory, and any combination thereof. In an aspect, for example, memory 530 may be a computer-readable storage medium (e.g., a non-transitory medium) that stores computer-executable code. The computer-executable code may define one or more operations or functions of the broadcast TWT indication component 540 and/or one or more of any subcomponents, and/or data associated therewith. The computer-executable code may define these one or more operations or functions when AP 105 is operating processor 503 to execute the broadcast TWT indication component 540 and/or one or more of any subcomponents. In some examples, the AP 105 may further include the transceiver 506 for transmitting and/or receiving one or more data and control signals (e.g., messages) to/from an STA. For example the AP 105 may transmit beacon requests and may receive beacon reports, may also transmit broadcast probe responses, FILS discovery frames, or both. The transceiver 506 may comprise hardware, firmware, and/or software and may be configured to execute code or perform instructions stored in a memory (e.g., a computer-readable storage medium). The transceiver 506 may include one or more radios, including a radio 507 comprising a transmitter 508 and a receiver 515. The radio 507 may utilize one or more antennas 502 (e.g., antennas 502-a, . . . , 502-n) for transmitting signals to and receiving signals from a plurality of STAs. The receiver 515 may include one or more components that form a receiving chain and the transmitter 508 may include one or more components that form a transmitting chain.

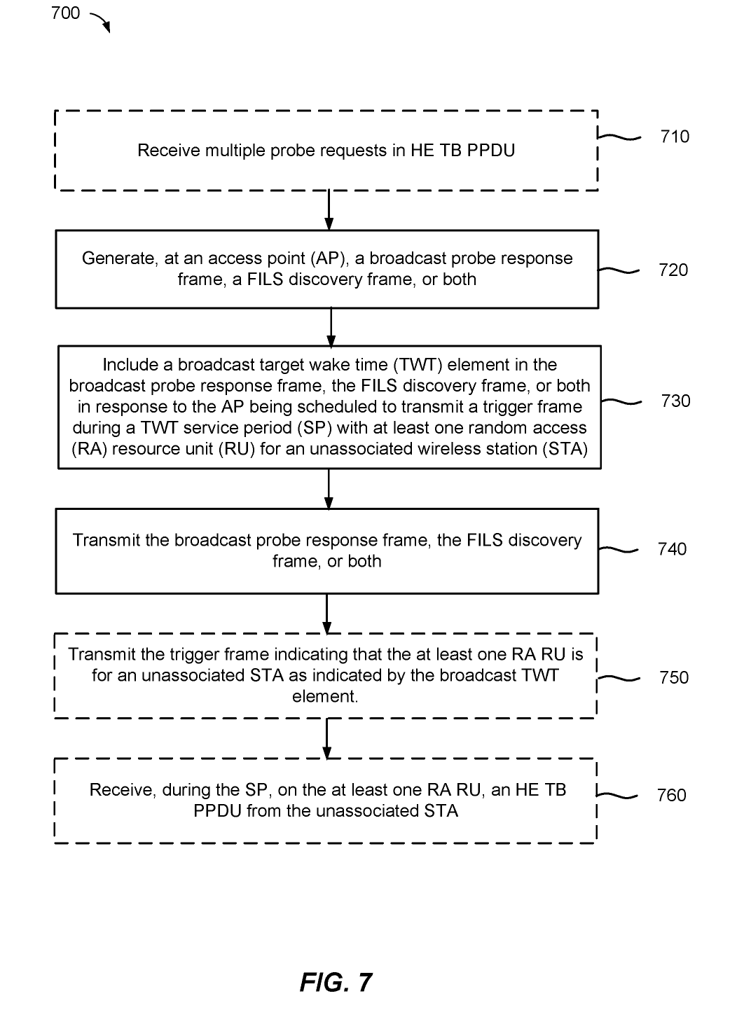

The broadcast TWT indication component 540 may be configured to perform, alone or in combination with other components of the AP 105, at least the functions described in connection with method 700 in FIG. 7.

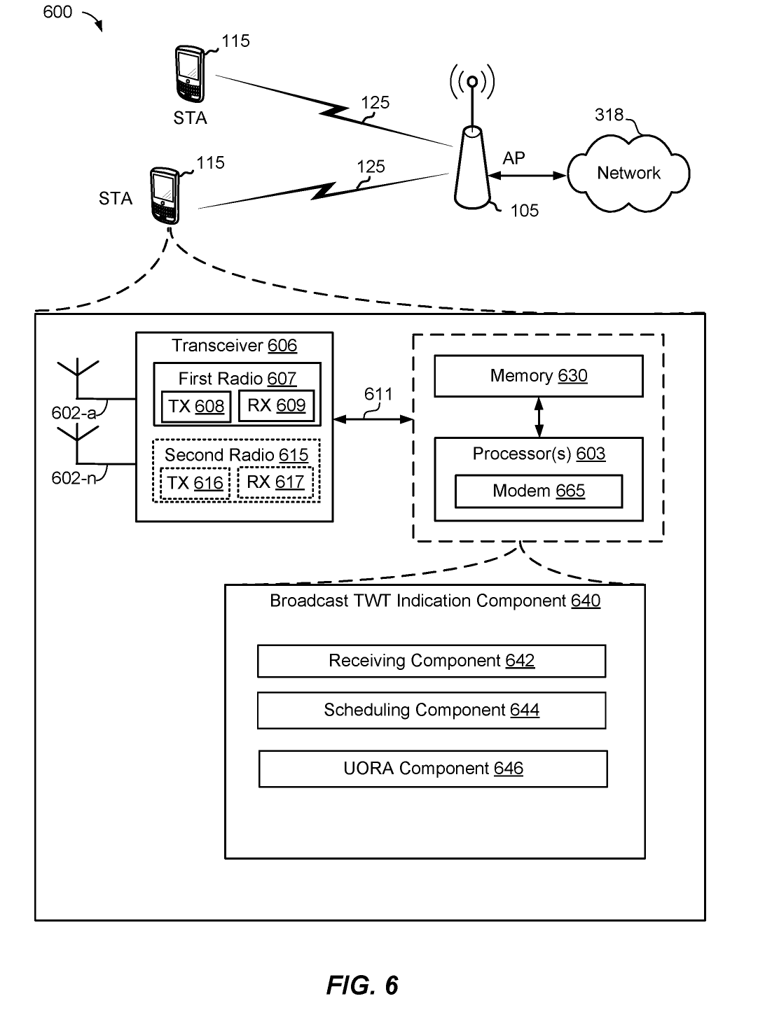

Referring to FIG. 6, in an aspect, a wireless communication system 600 is shown similar to the wireless communication system 500 in FIG. 5. In an aspect, one or more of the STAs 115 may be configured to participate in the beacon request/report mechanism described herein.

In accordance with the present disclosure, an STA 115 may include a memory 630, one or more processors 603 and a transceiver 606. The memory 630, the one or more processors 603 and the transceiver 606 may communicate internally via a bus 611. In some examples, the memory 630 and the one or more processors 603 may be part of the same hardware component (e.g., may be part of a same board, module, or integrated circuit). Alternatively, the memory 630 and the one or more processors 603 may be separate components that may act in conjunction with one another. In some aspects, the bus 611 may be a communication system that transfers data between multiple components and subcomponents of the STA 115. In some examples, the one or more processors 603 may include any one or combination of modem processor, baseband processor, digital signal processor, and/or transmit processor. Additionally or alternatively, the one or more processors 603 may include a modem 665 having a broadcast TWT indication component 640 for carrying out one or more methods or procedures described herein in connection with an STA (e.g., an unassociated STA). The broadcast TWT indication component 640 may comprise hardware, firmware, and/or software and may be configured to execute code or perform instructions stored in a memory (e.g., a computer-readable storage medium).

For example, the broadcast TWT indication component 640 may include a receiving component 642, a scheduling component 644, and a UORA component 646.

The receiving component 642 may include hardware, firmware, and/or software executable by a processor and may be configured to receive one or more broadcast messages such as a beacon, broadcast probe response, or FILS discovery frame. The receiving component 642 may monitor a channel for a periodic beacon and/or FILS discovery frame. In an aspect, the FILS discovery frame may be received on a shorter period than the beacon. The receiving component 642 may also be configured to receive a trigger frame indicating a RA-RU for unassociated STAs.

The scheduling component 644 may include hardware, firmware, and/or software executable by a processor and may be configured to determine resources for transmissions. For example, the scheduling component 544 may determine when a SP including a trigger frame indicating a RA-RU for unassociated STAs is to occur based on a TWT element received at the STA in a broadcast probe response frame, FILS discovery frame, or both. The scheduling component 644 may also determine the timing of the indicated RA-RU.

The UORA component 646 may include hardware, firmware, and/or software executable by a processor and may be configured to perform a UORA procedure. For example, the UORA component 646 may transmit HE TB PPDUs, and receive a Multi-STA acknowledgment.

In some examples, the memory 630 may be configured for storing data that is used in connection with local applications, and/or in connection with the broadcast TWT indication component 640 and/or one or more of any subcomponents being executed by the one or more processors 603. Memory 630 can include any type of computer-readable medium usable by a computer or processor 603, such as random access memory (RAM), read only memory (ROM), tapes, magnetic discs, optical discs, volatile memory, non-volatile memory, and any combination thereof. In an aspect, for example, memory 630 may be a computer-readable storage medium (e.g., a non-transitory medium) that stores computer-executable code. The computer-executable code may define one or more operations or functions of the broadcast TWT indication component 640 and/or one or more of any subcomponents, and/or data associated therewith. The computer-executable code may define these one or more operations or functions when STA 115 is operating processor 603 to execute the broadcast TWT indication component 640 and/or one or more of any subcomponents. In some examples, the STA 115 may further include the transceiver 606 for transmitting and/or receiving one or more data and control signals (e.g., messages) to/from an STA. The transceiver 606 may comprise hardware, firmware, and/or software and may be configured to execute code or perform instructions stored in a memory (e.g., a computer-readable storage medium). The transceiver 606 may include multiple radios that enable the STA 115 to operate as a multi-mode device or client. In this example, the transceiver 606 may include a first radio 607 having a transmitter (TX) 608 and a receiver (RX) 609, and a second radio 615 having a TX 616 and a RX 617. The first radio 607 may be a WLAN or Wi-Fi radio and the second radio 615 may be a non-WLAN system or non-Wi-Fi system radio (e.g., an LAA radio, an LTE-U radio).

Each of the first radio 607 and the second radio 615 may utilize one or more antennas 602 (e.g., antennas 602-a, . . . , 602-n) for transmitting signals to and receiving signals from an AP. The receivers 609 and 617 may include one or more components that form a receiving chain, and the transmitters 608 and 616 may include one or more components that form a transmitting chain.

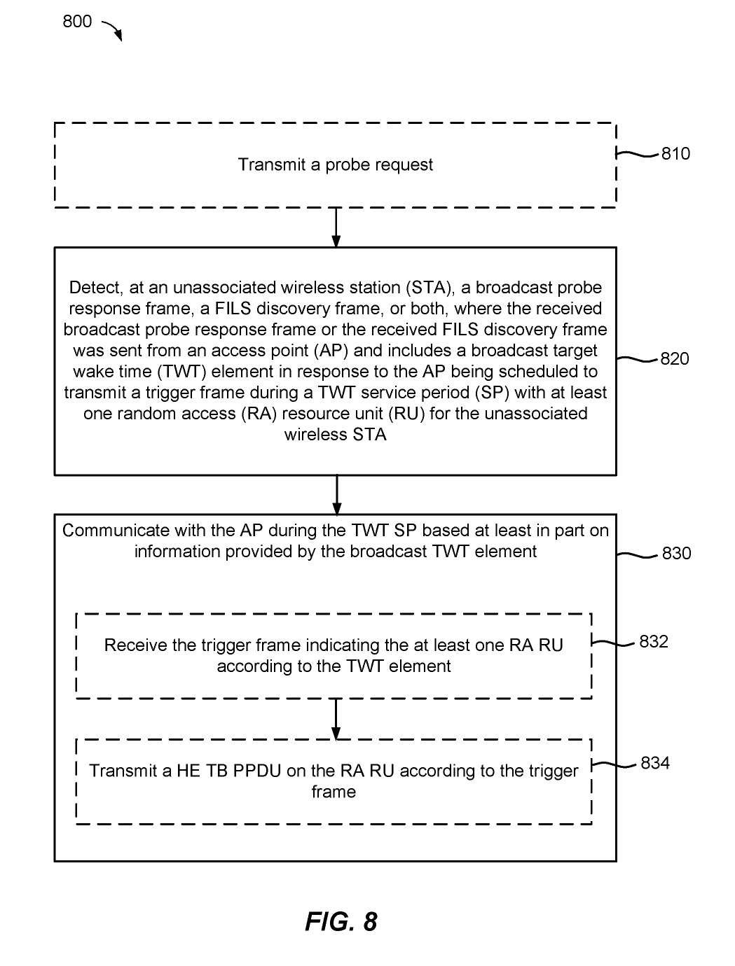

The broadcast TWT indication component 640 may be configured to perform, alone or in combination with other components of the STA 115, at least the functions described in connection with method 800 in FIG. 8.

Referring to FIGS. 7 and 8, examples of one or more operations related to the AP 105 (FIG. 5) and the STA 115 (FIG. 6) according to the present apparatus and methods are described with reference to one or more methods and one or more components. Although the operations described below are presented in a particular order and/or as being performed by an example component, it should be understood that the ordering of the actions and the components performing the actions may be varied, depending on the implementation. Moreover, it should be understood that the following actions may be performed by a specially-programmed processor, a processor executing specially-programmed software or computer-readable media, or by any other combination of a hardware component and/or a software component specially configured for performing the described actions or components.

FIG. 7 is a flow diagram illustrating an example of a method 700, in accordance with various aspects of the present disclosure.

At block 710, the method 700 optionally includes receiving, at an AP multiple probe requests in high-efficiency trigger based physical layer protocol data units (HE TB PPDUs). In an aspect, for example, the AP 105 may execute the UORA component 548 to receive multiple probe requests in HE TB PPDUs.

At block 720, the method 700 includes generating, at an AP (e.g., AP 105 in FIG. 5), a broadcast probe response frame, a FILS discovery frame, or both. In an aspect, for example, the AP 105 may execute the broadcast component 542 to generate the broadcast probe response frame 210, the FILS discovery frame 230, or both.

At block 730, the method 700 includes including a broadcast target wake time (TWT) element in the broadcast probe response frame, the FILS discovery frame, or both in response to the AP being scheduled to transmit a trigger frame during a TWT service period (SP) with at least one random access (RA) resource unit (RU) for an unassociated wireless station (STA). In an aspect, for example, the AP 105 may execute the scheduling component 544 to include the broadcast TWT element 220 in the broadcast probe response frame 210, the FILS discovery frame 230, or both in response to the AP 105 being scheduled to transmit a trigger frame during a TWT SP 402 with at least one RA RU 420 for an unassociated wireless STA.

At block 740, the method 700 includes transmitting the broadcast probe response frame, the FILS discovery frame, or both. In an aspect, the AP 105 may execute the transmitting component 546 to transmit the broadcast probe response frame 210, the FILS discovery frame 230, or both. In one aspect, the transmitting component 546 may use the transceiver 506, the processor 503, and/or the modem 565 for the transmission.

At block 750, the method 700 optionally includes transmitting the trigger frame indicating that the at least one RA RU is for an unassociated STA as indicated by the broadcast TWT element. In an aspect, for example, the UORA component 548 may transmit the trigger frame 410 indicating that the at least one RA RU 420 is for an unassociated STA as indicated by the broadcast TWT element. In one aspect, the UORA component 548 may use the transceiver 506, the processor 503, and/or the modem 565 for the transmission.

At block 760, the method 700 optionally includes receiving, during the SP, on the at least one RA RU, an HE TB PPDU from the unassociated STA. In an aspect, for example, the UORA component 548 may receive, during the SP, on the at least one RA RU 420, the HE TB PPDU from the unassociated STA 115. In one aspect, the UORA component 548 may use the transceiver 506, the processor 503, and/or the modem 565 for the transmission.

In another aspect, a method for wireless communications consistent with the method 700 may include generating, at an AP, a broadcast probe response frame, a FILS discovery frame, or both; including a broadcast TWT element in the broadcast probe response frame, the FILS discovery frame, or both in response to the AP being scheduled to transmit a trigger frame during a TWT SP with at least one RA RU for an unassociated STA; and transmitting the broadcast probe response frame, the FILS discovery frame, or both. The method may further comprise setting a TWT flow identifier to 2 to indicate that the trigger frame includes RA RUs. The method may further comprise indicating that the at least one RA RU is for an unassociated STA by assigning a corresponding AID12 value to 2045 for the at least one RA RU.

FIG. 8 is a flow diagram illustrating an example of a method 800, in accordance with various aspects of the present disclosure.

At block 810, the method 800 may optionally include transmitting a probe request. In an aspect, for example, the UORA component 646 may transmit the probe request. For example, the UORA component 646 may use the transceiver 606, the processor 603, and/or the modem 665 for the transmission.

At block 820, the method 800 includes detecting or identifying, at an unassociated STA (e.g., STA 115 in FIG. 8), a broadcast probe response frame, a FILS discovery frame, or both, where the received broadcast probe response frame or the received FILS discovery frame were sent from an AP and each includes a broadcast TWT element in response to the AP being scheduled to transmit a trigger frame during a TWT service period (SP) with at least one random access (RA) resource unit (RU) for the unassociated wireless STA. In an aspect, for example, the scheduling component 644 may detect or identify, at the unassociated STA (e.g., STA 115 in FIG. 6), a broadcast probe response frame 210, a FILS discovery frame 230, or both, where the received broadcast probe response frame or the received FILS discovery frame were sent from an AP 105 and each includes a broadcast TWT element 220 in response to the AP being scheduled to transmit a trigger frame 410 during a TWT SP 402 with at least one RA RU 420 for the unassociated wireless STA. In one aspect, the scheduling component 644 may use the processor 603, the modem 665, and/or the transceiver 606 for the detection or identification.

At block 830, the method 800 includes communicating with the AP during the TWT SP based at least in part on information provided by the broadcast TWT element. In an aspect, the STA 115 may execute the UORA component 646 to communicate with the AP 105 during the TWT SP 402 based at least in part on information provided by the broadcast TWT element 220. In one aspect, the UORA component 646 may use the transceiver 606, the processor 603, and/or the modem 665, for the communication. In an aspect, at block 832, the communication may include receiving the trigger frame 410 indicating the at least one RA RU 420 according to the broadcast TWT element 220. For example, the STA 115 may wake up and listen to the channel to receive the trigger frame 410. At block 834, the method may include transmitting a HE TB PPDU on the RA RU according to the trigger frame. For example, the STA 115 may identify one or more RA RUs 420 associated with an AID12 value of 2045 and randomly transmit on one of the identified RA RUs based on a contention procedure.

In another aspect, a method for wireless communications consistent with the method 800 may include detecting, at an unassociated STA, a broadcast TWT element in a broadcast probe response frame, a FILS discovery frame, or both received from an AP in response to the AP being scheduled to transmit a trigger frame during a TWT service period (SP) with at least one RA RU for an unassociated STA; and communicating with the AP based at least in part on information provided by the broadcast TWT element and during the TWT SP. A TWT flow identifier may be set to 2 to indicate that the trigger frame includes RA RUs. The at least one RA RU are indicated to be for an unassociated STA by assigning a corresponding AID12 value to 2045 for the at least one RA RU.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the disclosure can include a computer readable medium embodying a method for dynamic bandwidth management for transmissions in unlicensed spectrum. Accordingly, the disclosure is not limited to the illustrated examples.

While the foregoing disclosure shows illustrative aspects, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A method for wireless communications, comprising:
generating, at an access point (AP), a broadcast probe response frame, a FILS discovery frame, or both;
including a broadcast target wake time (TWT) element in the broadcast probe response frame, the FILS discovery frame, or both in response to the AP being scheduled to transmit a trigger frame during a TWT service period (SP) with at least one random access (RA) resource unit (RU) for an unassociated wireless station (STA); and
transmitting the broadcast probe response frame, the FILS discovery frame, or both.

2. The method of claim 1, further comprising setting a TWT flow identifier of the TWT element to 2 to indicate that the trigger frame includes RA RUs.

3. The method of claim 1, further comprising transmitting the trigger frame indicating that the at least one RA RU is for an unassociated STA as indicated by the broadcast TWT element.

4. The method of claim 3, wherein the trigger frame assigns the at least one RA RU for the unassociated STA a corresponding AID12 value of 2045.

5. The method of claim 1, wherein generating the broadcast probe response frame is in response to receiving multiple probe requests and includes a union of responses to each of the multiple probe requests.

6. The method of claim 1, wherein the broadcast TWT element includes a TWT parameter set field for only TWT service periods with at least one RA RU for the unassociated STA.

7. The method of claim 1, wherein the broadcast TWT element includes at least one TWT parameter set field that indicates a TWT service period with at least one RA RU for the unassociated STA.

8. The method of claim 1, further comprising receiving, during the SP, on the RA RU, a high-efficiency trigger based physical layer protocol data unit (HE TB PPDU) from the unassociated STA.

9. An access point (AP) for wireless communications, comprising:
a transceiver;
a memory; and
a processor communicatively coupled to the transceiver and the memory, the processor being configured to:
generate, at the AP, a broadcast probe response frame, a FILS discovery frame, or both;
include a broadcast target wake time (TWT) element in the broadcast probe response frame, the FILS discovery frame, or both in response to the AP being scheduled to transmit a trigger frame during a TWT service period (SP) with at least one random access (RA) resource unit (RU) for an unassociated wireless station (STA); and
transmit the broadcast probe response frame, the FILS discovery frame, or both.

10. The access point of claim 9, wherein generating the broadcast probe response frame is in response to multiple probe requests and includes a union of responses to each of the multiple probe requests.

11. The access point of claim 9, wherein the broadcast TWT element includes a TWT parameter set field for only TWT service periods with at least one RA RU for the unassociated STA.

12. The access point of claim 9, wherein any TWT parameter set field included in the broadcast TWT element indicates a TWT service period with at least one RA RU for the unassociated STA.

13. The access point of claim 9, wherein the processor is configured to receive, during the SP, on the RA RU, a high-efficiency trigger based physical layer protocol data unit (HE TB PPDU) from the unassociated STA.

14. The access point of claim 9, wherein the TWT element includes at least one TWT Parameter Information indicating a request type, target wake time, nominal minimum TWO wake duration, TWI wake interval mantissa, and broadcast TWT info.

15. The access point of claim 9, further comprising transmitting the trigger frame indicating that the at least one RA RU is for an unassociated STA as indicated by the broadcast TWT element.

16. The access point of claim 15, wherein the trigger frame assigns the at least one RA RU for the unassociated STA a corresponding AID12 value of 2045.

17. The access point of claim 9, wherein the processor is configured to set a TWT flow identifier of the TWT element to 2 to indicate that the trigger frame will include RA RUs.

18. A method for wireless communications, comprising:
detecting, at an unassociated wireless station (STA), a broadcast target wake time (TWT) element in a broadcast probe response frame, a FILS discovery frame, or both received from an access point (AP) in response to the AP being scheduled to transmit a trigger frame during a TWT service period (SP) with at least one random access (RA) resource unit (RU) for the unassociated STA; and
communicating with the AP during the TWT SP based at least in part on information provided by the broadcast TWT element.

19. The method of claim 18, wherein a TWT flow identifier is set to 2 to indicate that the trigger frame includes RA RUs.

20. The method of claim 18, wherein communicating with the AP comprises:
receiving the trigger frame indicating the at least one RA RU according to the TWT element; and
transmitting a high-efficiency trigger based physical layer protocol data unit (HE TB PPDU) on the RA RU.

21. The method of claim 20, wherein the trigger frame assigns a corresponding AID12 value to 2045 to the at least one RA RU in the trigger frame indicating that the at least one RA RU is for an unassociated STA.

22. The method of claim 18, wherein the broadcast probe response frame is in response to multiple probe requests and includes a union of responses to each of the multiple probe requests.

23. The method of claim 18, wherein the broadcast TWT element includes a TWT parameter set field for only TWT service periods with at least one RA RU for the unassociated STA.

24. The method of claim 18, wherein any TWT parameter set field included in the broadcast TWT element indicates a TWT service period with at least one RA RU for the unassociated STA.

25. A wireless station (STA) for wireless communications, comprising:
a transceiver;
a memory; and
a processor communicatively coupled to the transceiver and the memory, the processor being configured to:
detect, at an unassociated wireless station (STA), a broadcast target wake time (TWT) element in a broadcast probe response frame, a FILS discovery frame, or both received from an access point (AP) in response to the AP being scheduled to transmit a trigger frame during a TWT service period (SP) with at least one random access (RA) resource unit (RU) for the unassociated STA; and
communicate with the AP during the TWT SP based at least in part on information provided by the broadcast TWT element.

26. The wireless STA of claim 25, wherein a TWT flow identifier is set to 2 to indicate that the trigger frame includes RA RUs.

27. The wireless STA of claim 25, wherein the processor is configured to
receive the trigger frame indicating the at least one RA RU according to the TWT element; and
transmit a high-efficiency trigger based physical layer protocol data unit (HE TB PPDU) on the RA RU.

28. The wireless STA of claim 27, wherein the trigger frame assigns a corresponding AID12 value of 2045 to the at least one RA RU in the trigger frame indicating that the at least one RA RU is for an unassociated STA.

29. The wireless STA of claim 25, wherein the broadcast probe response frame is in response to multiple probe requests and includes a union of responses to each of the multiple probe requests.

30. The wireless STA of claim 25, wherein the broadcast TWT element includes a TWT parameter set field for only TWT service periods with at least one RA RU for the unassociated STA.
